(19) United States
(12) Patent Application Publication
(10) Pub. No.: US 2022/0414572 A1
(43) Pub. Date: Dec. 29, 2022

(54) SYSTEM AND METHOD OF LAWN MOWING AND CARING SERVICES BASED ON LAWN PROFILE DATA

(71) Applicant: TEXAROBA TECHNOLOGY INC., Plano, TX (US)

(72) Inventor: Jia SONG, Tulsa, OK (US)

(73) Assignee: TEXAROBA TECHNOLOGY INC., Plano, TX (US)

(21) Appl. No.: 17/801,494

(22) PCT Filed: Feb. 26, 2021
(86) PCT No.: PCT/US2021/020107

§ 371 Date: Aug. 22, 2022

Related U.S. Application Data
(60) Provisional application No. 62/981,577, filed on Feb. 26, 2020.
(60) Provisional application No. 62/981,585, filed on Feb. 26, 2020.
(60) Provisional application No. 62/991,106, filed on Mar. 18, 2020.

(51) Int. Cl. G06Q 10/06; G06Q 10/04; A01D 34/00; H04W 4/40

(52) U.S. Cl. CPC G06Q 10/06316; G06Q 10/04; A01D 34/008; H04W 4/40; A01D 2101/00

(57) ABSTRACT

This invention relates to a system of lawn mowing and caring services. It comprises a lawn profile data information management system having lawn profile data stored therein; at least one mobile device for registered users, which communicates wirelessly with the lawn profile data information management system for requesting services; and at least one robotic lawn mower or lawn robot which works with the mobile device to acquire requisite lawn profile data from the lawn profile data information management system for the services before the robotic lawn mower or lawn robot can perform the requisite mowing or caring services on the specific piece of lawn.

### CROSS-REFERENCE TO RELATED APPLICATIONS

The present application relates to and claims priorities to U.S. Provisional Application No. 62/991,106, filed on Mar. 18, 2020; U.S. Provisional Application No. 62/981,585, filed on Feb. 26, 2020; and U.S. Provisional Application No. 62/981,577, filed on Feb. 26, 2020; the disclosures of which are incorporated herein by reference in the entirety as part of the present application. This application also relates to and claims priority to PCT/US21/016951, filed on Feb. 5, 2021, which claims priority to U.S. Provisional Application No. 62/971,805, filed on Feb. 7, 2020.

### FIELD OF THE INVENTION

The present invention relates to a system and a method of lawn caring services, primarily lawn mowing, and more particularly it relates to a system and method of lawn caring and mowing services on the basis of lawn profile data, that may be collected, created, stored, and used for lawn mowing and caring services on any pieces of lawns around the world. Moreover, the system and method of the present invention is based on the lawn profile data, and therefore, a designated and authorized robotic lawn mower or robot can operate based on the specific lawn profile data as acquired and processed through, and stored at a lawn profile data information management system as disclosed in the related U.S. Provisional Application No. 62/981,577 and U.S. Provisional Application No. 62/981,585 of the same applicant.

### BACKGROUND OF THE INVENTION

Currently available in the market are primarily two types of robotic lawn mowers, but none is based lawn profile data or generally for any lawncare services. Those robotic lawn mowers may be referred to as the border wiring technology or radio beacons technology. Both of those technologies are used to define boundaries of any piece of lawn that would use the robotic lawn mowers to perform mowing of the lawn within the boundary. With the border wiring technology, the border wires are preset up or buried into the ground around or along every inches of the physical boundaries of the lawn; and the robotic lawn mower may then move around within the boundaries of the lawn as so defined, and no other measurement is needed because there is no other aspects about the lawn will be needed besides the boundaries of the lawn. Likewise, with the radio beacons technology, several radio beacons are planted or preset up at appropriate locations of the boundaries of any piece of lawn, and thus the robotic lawn mower may move around the lawn with reference to the radio beacons.

The most common practice now is still to bury low voltage wires into ground and mark the boundaries of the lawn. The robotic lawn mower will mow the lawn or yard within the boundaries, most likely in a random pattern without any predetermined or defined mowing path plan. Thus, there is no guarantee as to how much time it will take to finish mowing the entire lawn without duplicated work. Therefore, this is not efficient.

The radio beacon technology was proposed in 2019, and it eliminates the necessity of burying of border wires around the physical boundaries of the lawn, but instead it would require placing or planting radio beacons around the boundaries of the lawn so that the robotic lawn mower can learn and memory the locations and radio characteristics of each and every beacon. However, the planted beacons have to stay in their exact locations at all time. Otherwise, the robotic lawn mower may get lost or may go beyond boundaries of the lawn if any beacon is missing or removed from the original location. This radio beacons technology may work fine with small residential yards, and the number of beacons may not be many and the beacons would not get lost or missing without notice. However, it may not be an easy and cost-effective way to use in commercial mowing of relatively large scale of lawns, such as football fields or golf courses, or some public areas, such as parks or roadsides, and so on. Moreover, the information of boundaries of the lawns defined by the planted beacons may be used and kept for the lawn mower that was initially setup to do the job. Such information or knowledge of the individual lawn cannot be shared easily with other iRobot mowers or Terra robots. Resetting of radio beacons would be necessary to do the job by anew mower.

In today's world, AI technology and bigdata are used to enhance and/or support lots of things, i.e., various new usage and/or applications, and to create lots of new innovations; and those technologies can certainly be adopted for applications in association with the widely used GPS or broadly referred to as GNSS, and Google maps for geolocations. It is observed that any individual lawns or any piece of lands may not change quite often, and tend to stay as is so long as the surrounding buildings or other fixtures are kept unchanged over time; and on the other hand, a lawn mower may need to be replaced for a new one when the old mower is worn out. Therefore, it is desirable that the information or knowledge of individual lawns may be shared easily with other mowers so that any new lawn mower may be ready to receive the information and knowledge of the lawns without too much trouble of presetting or installment of border wire or beacons. Further, it is desirable that other conditions of lawns would be considered as well so long as they may affect mowing jobs, such as, wetness of grass, slopes of the lawns or any instant changes of those conditions of the lawn. In sum, it is desirable for a completely new technology that may perform good quality of lawn mowing or possible for all kinds of lawncare services that will take into consideration of all aspects of information or knowledge of any pieces of lawns around the world.

### SUMMARY OF THE INVENTION

An object of the present invention is to provide a system and method of lawn mowing and caring services that may enable any robotic lawn mowers or any types of lawn robots to work on the basis of lawn profile data as processed through the lawn profile data information management system as disclosed in the related U.S. Provisional Application No. 62/981,577 and U.S. Provisional Application No. 62/981,585 of the same applicant.

Another object of the present invention is to provide a system and a method of lawn mowing and caring services for anyone to perform lawn mowing and caring works or jobs on the basis of the lawn profile data, and/or for anyone to download the shared lawn profile data to initiate any lawn robots and/or lawn mowers to perform the work or job easily and quickly so long as the person, user or operator and the lawn robots or mowers are authorized.

The other object of the present invention is to provide a system and method of lawn caring and mowing services that may offer affordable ways of lawn caring and mowing services based on sharing of lawn profile data as processed through the lawn profile data information management system of the related patent applications of the same applicant.

According to the present invention, a system of lawn mowing and caring services comprises a lawn profile data information management system; at least a mobile device which communicates wirelessly with the lawn profile data information management system; and at least a robotic lawn mower or a lawn robot which works with the mobile device to acquire requisite lawn profile data from the lawn profile data information management system, wherein the lawn profile data is collected, acquired and processed as data predetermined and designated to a specific piece of lawn before the robotic lawn mower or lawn robot can perform the requisite mowing or caring job on the specific piece of lawn.

According to the present invention, the mobile device may be any one of a mobile data processor, a mobile information processing device, and a data processing unit as part of an operation panel of the robotic lawn mower or lawn robot so long as the mobile device is equipped with an APP for lawn profile data processing.

According to the present invention, the lawn profile data information management system adopted in this system of lawn mowing and lawn caring services for robotic lawn mowers and/or lawn robots, as disclosed in U.S. Provisional Application No. 62/981,577, comprises at least a lawn profile information collector (which is disclosed in U.S. Provisional Application No. 62/981,585), and a lawn profile data converter and a data processor which may be separate or in one apparatus or part of the lawn profile information collector for collecting lawn profile information and creating lawn profile data; and a remote information processing center for processing and storing the lawn profile data, wherein the remote information processing center may be one or a plurality of servers or just a cloud-based storage or services, which is capable of communicating wirelessly with the lawn profile information collector and/or processor, as well as lawn robots or lawn mowers.

The system of lawn mowing and lawn caring services of the present invention further comprises a mobile device that is adopted or communicates wirelessly with the lawn profile data information management system to send a request or work order for obtaining such lawn profile data associated with and designated to a specific piece of lawn that needs mowing and/or caring jobs, when a user or operator will need to use a lawn robot or robotic lawn mower for the mowing and/or caring jobs on the specific piece of lawn; and the mobile device will then be used by the user or operator to obtain or download the requisite lawn profile data that has been collected, processed, stored or kept at the lawn profile data information management system in order to initiate the mowing and/or caring jobs.

In addition to the lawn profile data information management, the system of lawn mowing and caring services of the present invention comprises user registration and verification management unit, with which any of potential users shall register in advance; equipment registration, verification and management at which any of potential lawn robots or mowers shall be registered in advance and updated from time to time; as well as management of tasks and resources, when a job or work order or request is placed through the mobile device. However, all of those managements may be based on cloud services in association or cooperation with the lawn profile data information management system. That is, to be an authorized user, a user or operator of a lawn robot or mower will need to set up an account with the user registration and verification management unit or system so that the user may request authentication, and then send the request for a job order for lawn mowing and caring after the authentication. All of registrations and requests are sent from mobile devices that are equipped with respective APPs for various users.

The details and other aspects of the present invention will be described hereinafter in connection with the accompanying drawings.

### BRIEF DESCRIPTION OF THE DRAWINGS

FIG. 1 illustrates generally the system of lawn mowing and caring services according to the present invention, in connection with the lawn profile data information management system.

FIGS. 2a and 2b illustrate necessary functions of the mobile device of the system of lawn mowing and caring services, indicative of APP for owners and APP for customers according to the present invention.

FIG. 2c shows the necessary functions of the mobile device of the system of lawn mowing and caring services, indicative of APP for professionals or service providers.

FIGS. 3a and 3b show two operations of the mobile device that are reflected from the APP for Owners as individual users to request the lawn data collection and/or lawn data usage according to the present invention.

FIG. 3c shows the operation of the mobile device for placing a job order request, that is reflected from the APP for Customers as individual users.

FIG. 4a shows a flow chart of processing the request for lawn profile data collection by professional users of the system of lawn mowing and caring services.

FIG. 4b shows a flow chart of processing the request for lawn caring or mowing jobs by professional users, using the system of lawn mowing and caring services.

FIG. 5 shows an example of the information and knowledge of lawns for the lawn profile data in connection with a piece of residential lawn.

FIG. 6 illustrates the registration of an individual user as Customer of the system of lawn mowing and lawn caring services of the present invention.

FIG. 7 shows the registration of an individual user as Owner and Product owned with the system of lawn mowing and lawn caring services of the present invention.

FIG. 8 is the registration of a professional user for performing the services of the system of lawn mowing and lawn caring services of the present invention.

FIG. 9 is the registration of a leased product or equipment of lawn mower or lawn robot at the system of lawn mowing and lawn caring services of the present invention.

FIG. 10 shows the operations of the system of lawn mowing and caring services of the present invention for Owners.

FIG. 11 shows the operations of the system of lawn mowing and caring services of the present invention for Customers.

FIG. 12 shows the lawn data collection by the Professionals according to the system of lawn mowing and caring services of the present invention.

FIG. 13 illustrates generally the respective main managements of user, lawn profile data, equipment, tasks, and resources of the system of lawn mowing and caring services according to the present invention.

### DETAILED DESCRIPTION OF THE INVENTION

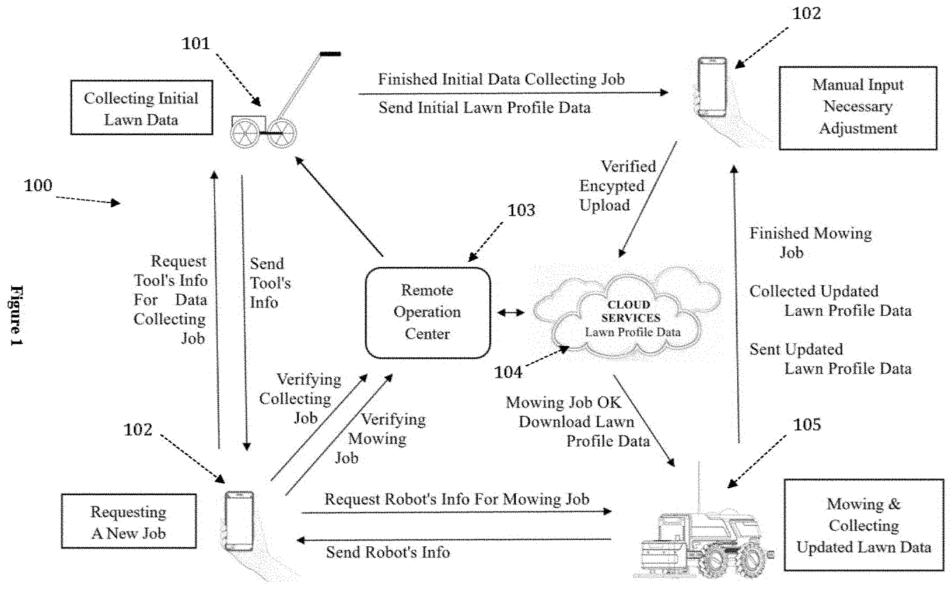

With reference to FIG. 1, the system of lawn mowing and caring services comprises at least a mobile device in communication wirelessly or telecommunication with a lawn profile data information management system which comprises at least a lawn profile information collector and lawn profile data converter and/or processor, that measures or collects lawn profile information to be converted to lawn profile data to reflect all possible aspects of any pieces of lawns in association with the lawn profile data information management system; wherein the lawn profile data information management system includes a remote information processing center and/or storage, such as, cloud storage or services, that stores or keeps the lawn profile data acquired and uploaded from the lawn profile information collector and data processor for using of future lawn mowing and caring jobs, and for sharing with any authorized users who will take care of the specific piece of lawn according to the system of lawn mowing and lawncare services. For a user to be authorized to use an authorized equipment, i.e., lawn robot or mower, the user must register with the user registration and verification management system, and so is the equipment to be registered at the equipment registration and management system according to the present invention. Nonetheless, the possible lawn profile information reflecting all aspects of any pieces of lawns may include the geolocations, sizes, boundaries, slopes of the lawn, as well as any obstacles or fixtures on any specific piece of lawn.

The general concept of the present invention is that the lawn profile data of a piece of lawn will remain relatively unchanged for most of time because physical conditions of the lawn may not change often unless the surrounding buildings or fixtures change permanently, which may be known in advance; and the collection of such lawn profile data for use on the specific lawn as designated or tagged by the data can be shared by any robotic lawn mower or lawncare robot to perform the lawn mowing and caring jobs at any time afterwards so long as the robotic lawn mower or lawncare robot is verified as being authenticated and the user is verified as being registered and authorized user or users. The collection of lawn profile data may be kept and stored at cloud storage or rather at the lawn profile data information management system, and may be updated from time to time. Therefore, it can be understood that the shared lawn profile data may then enable any robotic lawn mower or lawn robot to perform the desired lawn mowing or caring jobs efficiently, and that is to say it would be more intelligent than the border wiring technology and radio beacons technology. This is because the desired and requisite lawn mowing and caring jobs can be done in accordance with any predetermined choices of mowing and/or caring plans on the basis of the lawn profile data, which is created in consideration of all possible aspects of any pieces of lawns.

As the basis of the system of lawn mowing and caring services of this invention, the lawn profile data information management system has been disclosed in the related patent application U.S. Ser. No. 62/981,577; and the lawn profile data collector and processor has been disclosed in the other related patent application U.S. Ser. No. 62/981,585, also known as lawn profile data collecting tool. The various ways of using the lawn profile data are the main contents of this application, that are designed for users with registrations and accounts with the system of lawn mowing and caring services in accordance with the present invention.

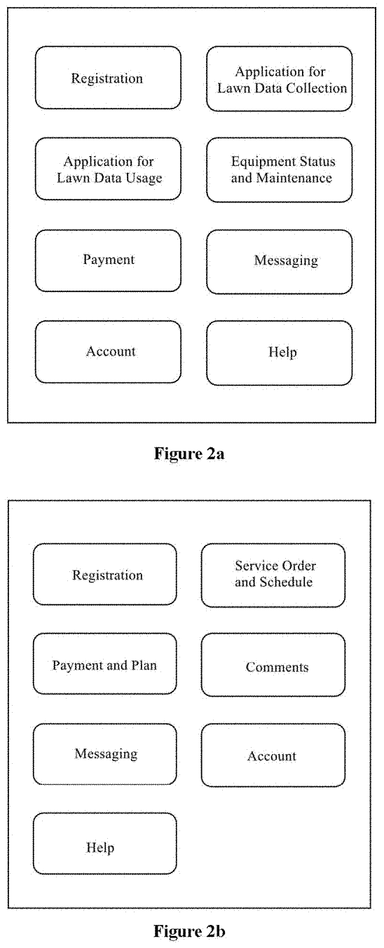

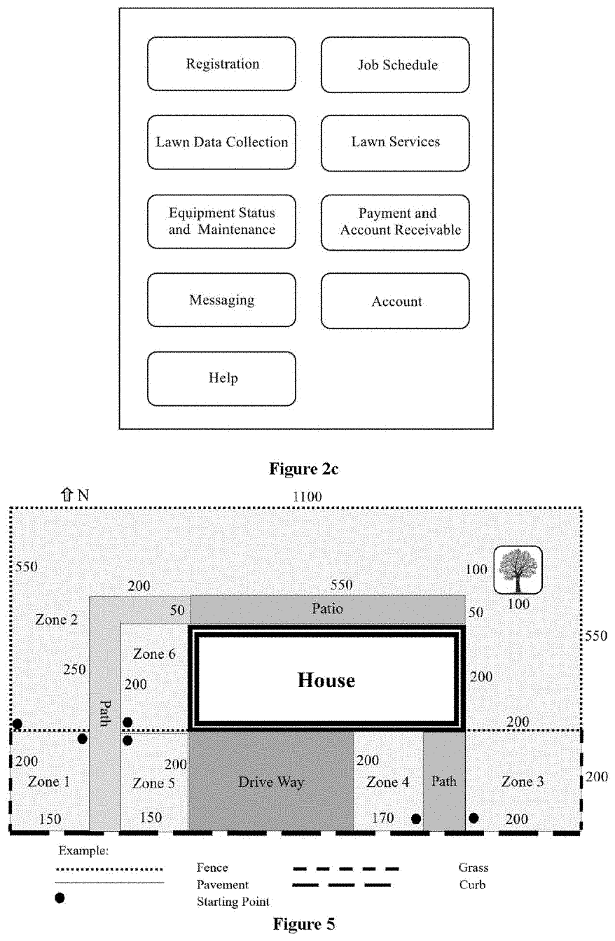

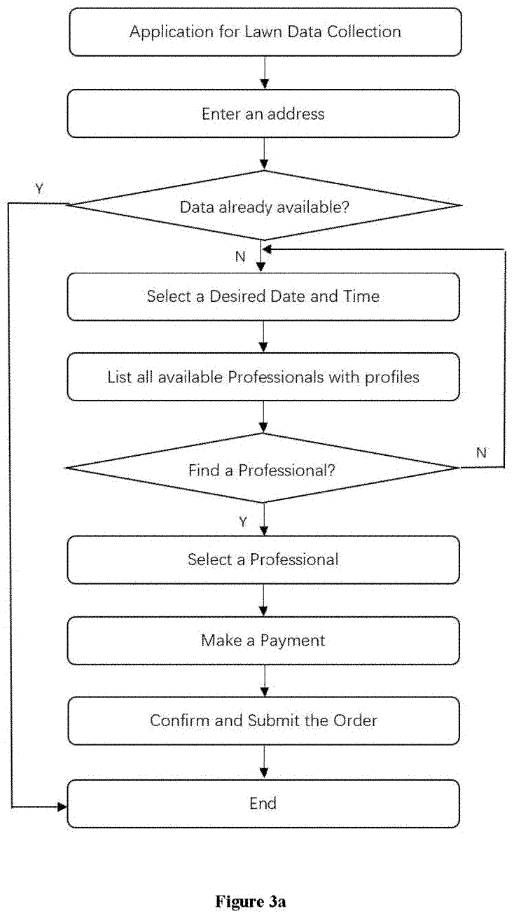

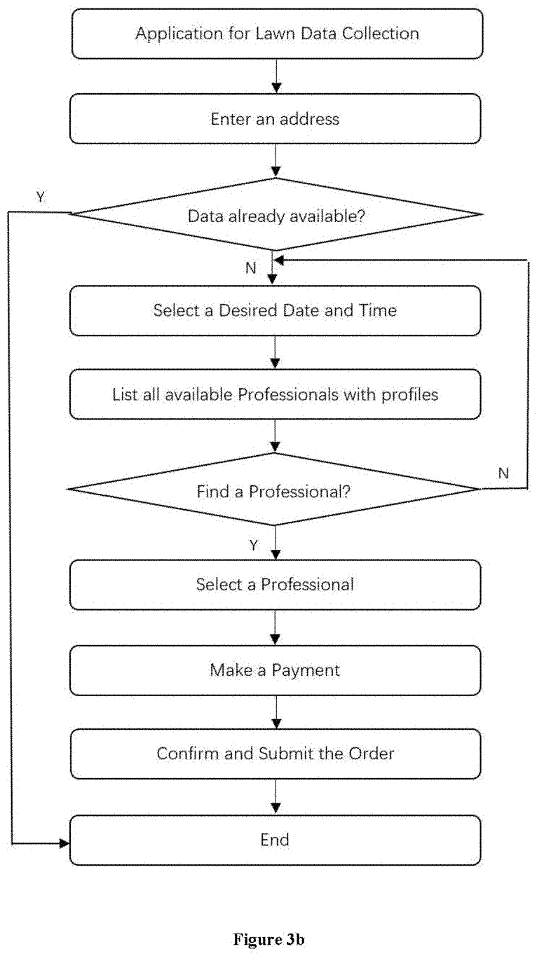

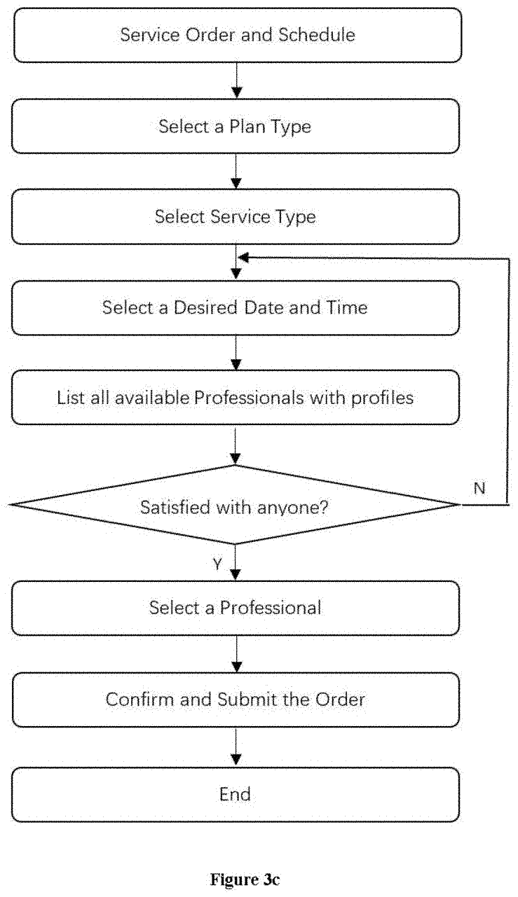

Here “user” or “users” refer to anyone who may use a mobile device as well as a lawn robot or robotic lawn mower and who needs to communicate with the lawn profile data information management system to place an order for a lawn caring and/or mowing job and to download the requisite lawn profile data for the jobs. The user or users may be someone who needs to mow or take care of a specific piece of lawn; or someone who also owns a robotic lawn mower or lawn robot himself or herself or someone who will actually operate the lawn robot or mower to perform the requisite jobs. For easy identification, the ones who need to order and schedule lawn caring and mowing services may be called “customers” and the ones who need lawn caring or mowing services and also own lawn robots or mowers may be called “owners”; and the persons who will take orders of and work on the lawn mowing and/or caring jobs may be referred to as “professional users” or “professionals” or “service providers.” The operational APPs on the mobile devices will be designed a bit differently for the “customers,” “owners,” or “professionals” as shown in FIGS. 2a, 2b, and 2c; and the operations of the APPs are explained in FIGS. 3a, 3b, and 3c.

In FIG. 2a, the mobile device is configured to include a registration module, a lawn data collection module, a lawn data usage module, equipment status module, as well as payment, message, account, and help, etc., all integrated in an APP for “Owners” who also own lawn robots or mowers themselves. In FIG. 2b, the mobile device is configured to include, primarily, a registration module and service order module, as well as payment plan, account, message and comment functions integrated in an APP for “Customers” who would need to order mowing and/or caring services on a piece of lawn of his or hers but do not have a lawn robot or mower. It means that Customers may place a job order online with the system of lawn mowing and caring services and to select a service provider, i.e., professional or professional user. FIG. 2c shows the mobile device that is configured to include modules or functions of registration, job schedule, lawn data collection, lawn services, equipment status, payment and account receivable, account, as well as message and help; integrated in an APP for Professionals.

As stated above, the Owners are those who have purchased and thus own lawn robots or mowers themselves; and thus, they should be entitled to use the lawn profile data of this system of lawn mowing and caring services to operate their own lawn mowers or lawn robots. However, collection of lawn profile data may still be necessary if it is the first time for the Owner to perform or conduct lawn mowing and/or caring jobs on a piece of lawn, and there is no previous lawn profile data is available or stored on the lawn profile data information management system. The lawn profile data collection should be free of charge for the Owner's own piece of lawn at the owner's primary address provided that the Owner is registered and the lawn robot or mower of the Owner is then authorized, certified and registered with the system of the present invention. Further, the Owner may want to use the lawn mower or robot for lawn mowing and caring jobs on other pieces of lawns of friends and family members; and the use of lawn profile data for others' lawns will be charged for fees. Nonetheless, the lawn data collection will be handled differently with upfront payment and then credit in several installments to cover the fees for using the lawn profile data; and the details are described in view of FIGS. 3a and 3b, respectively, for lawn data collection and lawn data usage through interaction of the owner or user and the mobile device with APP for Owners.

As an example, the process of application for the lawn profile data collection is shown in FIG. 3a. After the Owner's registration to open an account with the system, the application for lawn data collection needs to be inputted on the mobile device with the Owners APP of FIG. 2a; and then be prompted for entering an address of a specific piece of lawn of their own primary addresses (if the lawn caring and mowing jobs are to be done using their own lawn robots or mowers on the owner's lawn) or an address of a specific piece of lawn other than their primary addresses; and afterwards, the system will check to see whether or not the lawn profile data is available for the specified lawn; and if “N” (not), the mobile device will prompt an inquiry for scheduling “date and time” to conduct the data collection; and show a list of all available professionals on the scheduled date and time to choose therefrom. Once selected, the mobile device will generate prompts of “make a payment”, and “confirm and submit the order”. The selected professional will conduct the data collection as scheduled; and afterwards the lawn profile data for the specific piece of lawn will be available on the system for future use.

In any event, the payment will be “zero” if the primary address of the Owner is entered earlier. The payment of fees for lawn data collection should be made upfront, but the paid fees will be reimbursed to the owner in a number of installments as credit towards the usage of the lawn profile data for the mowing and/or caring jobs on the others pieces of lawns, i.e., other than the lawn at the Owner's primary address, or the lawn or lawns of the Owner's own other address or addresses.

FIG. 3b shows how an Owner applies for lawn profile data usage for mowing and/or caring jobs to be performed on others pieces of lawns, that is, at an address other than the owner's primary address. With the interactive flow chart of FIG. 3b as on the mobile device with the Owners APP of FIG. 2a, the system will determine right away where the lawn mowing and caring jobs will be performed when an address is entered, that is, the entered primary address will indicate the jobs will be performed on the Owner's own piece of lawn; and otherwise, it will be determined to have the jobs done on others' pieces of lawn. Then, the mobile device will prompt for scheduling “date and time” of the lawn mowing or caring job; and the system will check any conflict and then the mobile device will prompt for making a payment. Again, the entered address will decide if the payment of fee should be free or not free; that is, the payment should be zero if the entered is the primary address of the owner, and a predetermined amount of fees will be shown and be processed for payment. For the first predetermined number of uses of lawn profile data for the jobs (such as four times), the previously paid “lawn data collection fees” will be credit and applied to cover the usage fees. It is understood that actual fees will be based on the factors of lawn size, difficulty level, and time to finish; and those will be generated by the system, and may be updated from time to time since lots of conditions or situations may change.

FIG. 3c is the process of the mobile device with the Customers APP of FIG. 2b, showing the interactive process for the Customer to order lawn caring or mowing services through the system of the present invention. The Customer will initiate the Service Order and Schedule on the Customers APP of the mobile device; and then select a type of service plan as to how often the Customer would like to have the services. It may include, but not limited to at least the following types: weekly or biweekly for a year; weekly or biweekly for half year; weekly or biweekly for three months; weekly for a whole month (i.e., four times), or just one-time deal, and so on. The Customer may then select the types of services, for instance, mowing, fertilizing, weed controlling, leaf collecting, and so on. Once done, the mobile device will prompt for selection of desired date and time; and selection of available professionals from a list of professional service providers with details of profiles, until satisfactory with the selection. Then, the payment of service fees will be made through the APP of the mobile device; and the service order will be submitted and confirmed, for which the system will generate a service agreement, a payment receipt and a notice of schedule. The mobile device will remind the Customer user at appropriate times, such as a day before and then a few hours before the schedule.

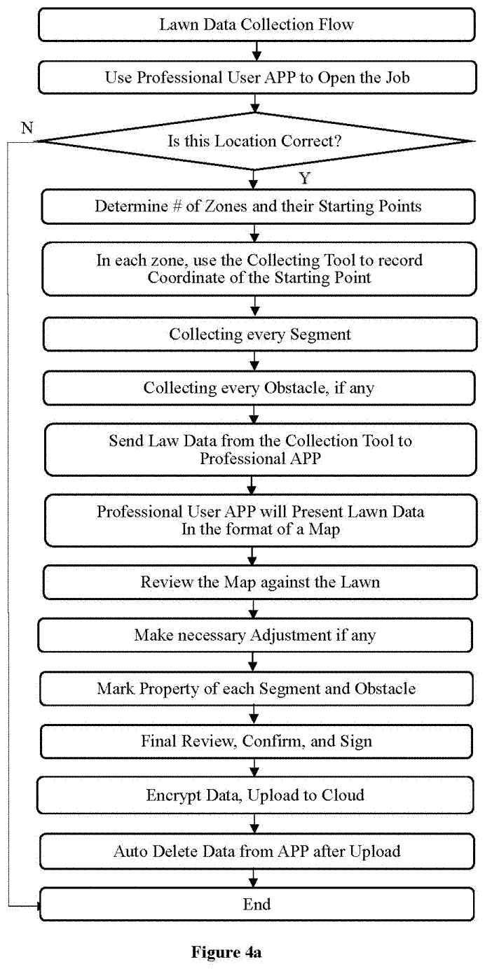

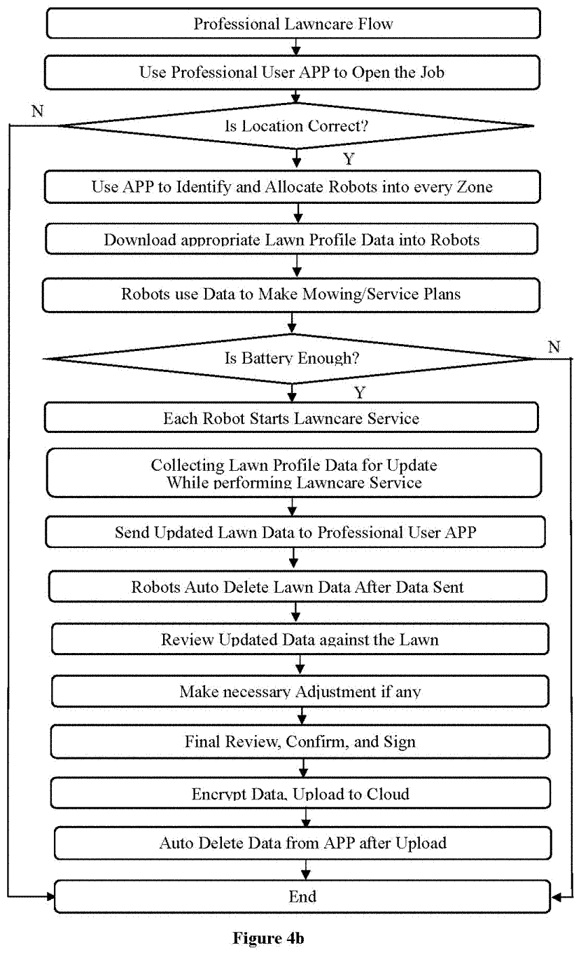

Once the Owner or Customer schedules an order of “lawn data collection,” the selected professionals will then show up at the time and location as scheduled, and the mobile device with the Professionals APP of FIG. 2c will start the interactive flow chart as shown in FIG. 4a. First, the Professional APP of the mobile device opens the job order and the system will automatically confirm whether the location is correct. If “Y” (yes), the Professional service provider will then use a lawn information collector and lawn data converter and processor as registered, which may be the apparatus of lawn profile data collection or rather the lawn profile data collecting tool as described in the related patent application U.S. Ser. No. 62/981,585, which is incorporated herein by reference. Generally, it determines the number of zones and their starting point; and records the coordinate of the starting point; and collects every segment of the zone, as well as every obstacle, if any, within the zone. The collected information of the piece of lawn will be processed or converted, and sent to the Professional APP, which may be presented in a color graphic map as an example in FIG. 5. On the APP of the mobile device, the professional review the map against the lawn; make any necessary adjustment; mark property of each segment and obstacle; and finalize the review by signing or executing the map to confirm; and the mobile device will encrypt the data and upload to Cloud for storage or rather to the lawn profile data information management system with the Cloud. And the processed data will be removed or deleted automatically from the mobile device.

As shown in FIG. 4b, to perform the scheduled lawn caring and/or mowing jobs, the mobile device with the professional APP of FIG. 2c will open the job order and detect to confirm whether or not the location is correct for the scheduled lawn; and identify the lawn robot for authentication, and allocate the robots correctly into every zone that needs lawn caring and/or mowing. After the identification of the lawn robot or mower as authorized product or equipment, the mobile device will then download the lawn profile data as specified for the particular piece of lawn from the lawn profile data information management system, and the lawn robot or mower may then be ready to perform the scheduled mowing or caring job; while the battery or power level will be checked to assure the completion of the scheduled jobs, before the lawn robot or mower starts working. The checking of equipment registration and status, etc. and checking of the order as task, etc. will be conducted at the equipment management and task management system according to the present invention which is illustrated briefly in FIG. 13.

The performance of the scheduled lawn mowing and/or caring jobs may be illustrated in the graphic map shown in FIG. 5, imitating the actual piece of lawn, i.e., the lawn robot or mower will start at the starting point of each zone, and work on each of zones to cover all segments thereof in view of the properties of the zone. Likely, the “job” on the specific piece of lawn may be performed simultaneously using more than one lawn robots or mowers, i.e., each may work on one or more zones so that the mowing or caring jobs may be finished quickly.

Further in FIG. 4b, the lawn robot or mower is equipped with a sensing and detecting system, including, such as, laser sensors or radar, and so on, as disclosed in the related patent application of the same applicant, i.e., U.S. Ser. No. 62/971,805, incorporated herein by reference. The lawn robot or mower will collect actual conditions of the lawn instantly, which may be used for adjustment, if needed, for the scheduled mowing or caring jobs. Once the mowing or caring job finishes, the detected information and modification of the lawn data will be determined to see if the “change” is permanent. Regardless the change is instant or permanent, any updates of lawn data or the updated lawn data will be encrypted and uploaded to the lawn profile data information management system with Cloud storage, that is, the lawn management or lawn data management system of the present invention as seen in FIG. 13 below. Then, the scheduled mowing or caring job is finished.

The system of lawn caring and mowing services of the present invention will calculate the fees and update the same to the accounts of the Customers or Owners at the task management as seen in FIG. 13 after the completion of the lawn data collection or lawncare job as shown in FIGS. 4a and 4b. That is, the credit for the lawn data collection will be applied to the account of Owner who let others use his or her lawn robot or mower to do the scheduled jobs on the others' lawns. However, any fees for using the lawn profile data to do the mowing or caring jobs will be settled on the accounts of the Owners and/or Customers.

The general operations of the system of lawn caring and mowing services have been described hereinabove, in connection with the user management, lawn or lawn data management, equipment management, and task management, as well as resources management of the system of the present invention, for the Customers, Owners, and Professionals or professional service providers. It can be understood that all of them should be registered with the system of lawn caring and mowing services at the user management (shown in FIG. 13) so as to be entitled to use the lawn profile data of the system of lawn caring and mowing services of the present invention. In other words, the system of lawn caring and mowing services is backed up by the lawn profile data.

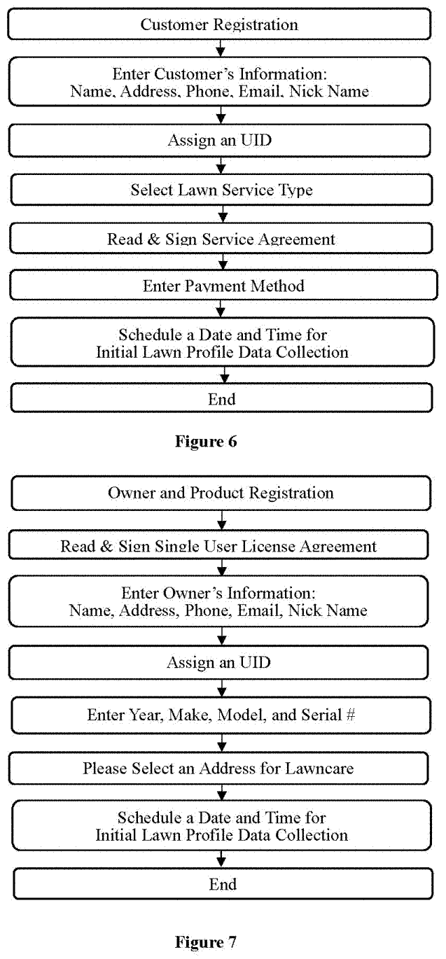

As more details about the user management of the system of the present invention, FIG. 6 illustrates the registration of Customers as individual users with the system of lawn mowing and caring services of the present invention. First, Customers will need to download an APP on their mobile devices, and get registrations with their information of name, address, phone number, email, and nickname or username, etc. The system will then assign a user ID, i.e., UID to identify each of the Customers. Each of the Customers will then schedule “date and time” for an initial lawn profile data collection, that will be done by professionals as described above. As part of the registration, the Customers will need to select the type of lawn services and service plans; and then sign or execute a Service Agreement. Further, a method of payment will need to be entered or selected before finishing the registration. After the registration, the Customers may then order lawn mowing or caring services through the APP on the mobile devices, such as services of mowing, weed killing, fertilizing, leaf collecting, and so on.

As more details about the equipment or product management of the system of the present invention, FIG. 7 illustrates the registration of Owners and Products or Equipment with the system of lawn mowing and lawn caring services of the present invention. Owners should download the APP for Owners on their mobile devices and get their registration with the APP. Owners who have the purchased lawn robots or mowers will then need to execute the single user license agreement for their lawn robots or mowers to use the lawn profile data of this system; and the Owners are entitled to use their own lawn robots or mowers for others or others' lawns as described above. To register, the Owners should enter the information of name, address, phone number, email and nickname (or username); and then the system will assign a user ID or UID to the Owner. Further, the Owner will need to enter product information about the lawn robot or mower, such as, year, make, model, and serial number so that the lawn robot or mower becomes authorized product. Moreover, an address of the piece of lawn that need lawncare may be selected if the Owner has more than one location of lawns; and an initial lawn profile data collection may be scheduled for the lawn at the Owner's primary address as well an address of the lawn of the Owner's own. Afterwards, the scheduled lawn data collection may be done through the process as shown in FIG. 3a and FIG. 4a. Again, under the single user license, the Owner can use the lawn profile data for the lawn at his or her primary address free of charge. The complimentary lawn data collection will be provided as described above.

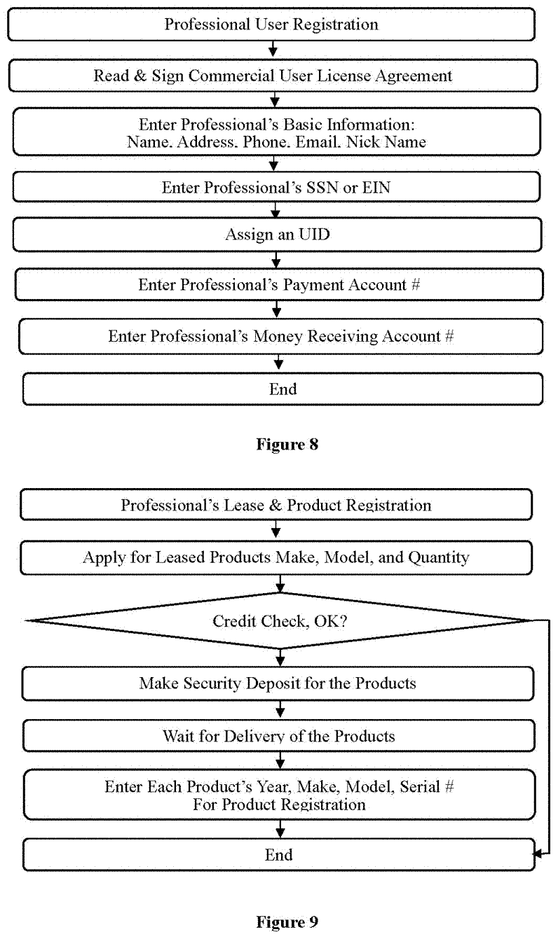

FIG. 8 is the registration of Professionals or Professional Users as service providers of lawncare services of the system of lawn mowing and caring services. After downloading the APP on the mobile device of the Professional, Professional will be prompted to read and sign Commercial User License Agreement, and then enter the basic information of the professional such as address, email, phone number, nickname or username, and so on, and also, the professional's SSN or EIN or the like for security checkup and for business use only. The system will then assign a user ID or UID. The registration will require selection of method of payment method and the account information for receiving payment for their services.

Still further, FIG. 9 is the registration of a leased product or equipment of lawn mower or lawncare robot with the system of lawn mowing and lawn caring services of the present invention. After the professional finishes the registration, the professional can apply for the leased equipment, such as, a robotic lawn mower, a lawn profile data collecting tool, and other lawncare robots. After credit check and approval by the system, the professional will need to pay a security deposit for the leased equipment; and after receiving leased equipment, enter the detailed information of every equipment being leased, such as, year, make, model, and serial number to complete the product registration, upon the delivery of the leased equipment.

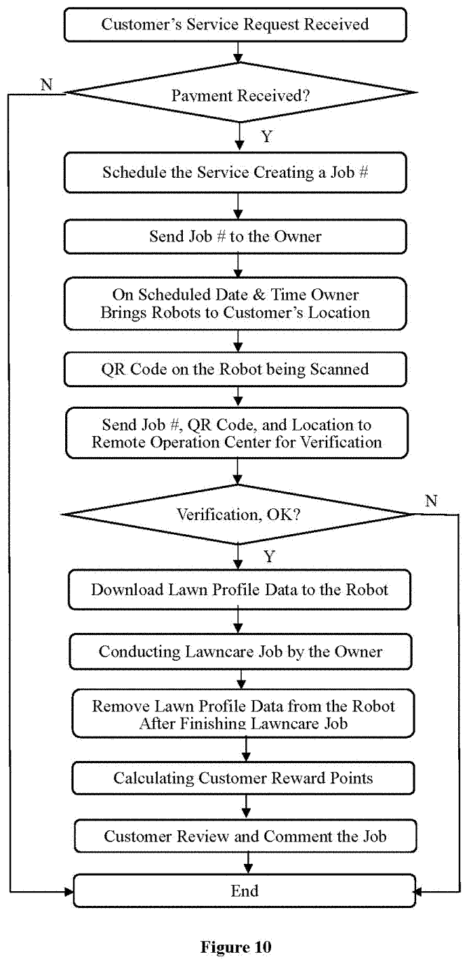

FIG. 10 shows generally the operational details of the system of lawn mowing and lawn caring services according to the present invention for Owners. When the system receives a service request from the mobile device of an Owner, the system will first check the payment records of the Owner to see if all the requisite fees are received in association with the service request. The system will schedule a service in the system, create a Job # (number) for the scheduled service, and then send the Job # as notice to the Owner who will use the mobile device of his or her own. The Job # notice includes the scheduled date and time of the service, location address of the lawn, the nature of the lawn mowing or caring jobs, which lawn robot or mower intends to use, and so on.

On the date of the schedule, the system will remind the Owner to bring the lawn robot or mower to the scheduled location which may be Owner's own lawn or other's lawn. The system will check to see if the location is correct for validation of address when the mobile device of the Owner is turned on upon the arrival of the Owner at the location of the lawn. Once the location is validated, the QR code (that contains the registration Code of the equipment) being scanned from the lawn robot will be sent from the mobile device of the Owner to the system for verification. Once the QR code information of the lawn mower or robot is verified, the system will download the requisite lawn profile data of the specified piece of lawn at the correct location to the lawn mower or robot, thereby enabling the initiation of the lawn mower or robot, i.e., getting ready to perform the scheduled lawn caring or mowing jobs as requested. The lawn mower or robot may then conduct the requisite service or services tagged by Job # from the system, on the basis of the downloaded lawn profile data which will generate a lawn mowing or caring plan as displayed on the mobile device of the Owner.

When job is done in accordance with the lawn mowing or caring plan, the downloaded lawn profile data will be automatically removed from the mobile device of Owner, and the Customer reward points be calculated and sent to the system to finish the job. Whilst the system may receive any comment as review about the experience, if the Customer chooses to put such comments or suggestion.

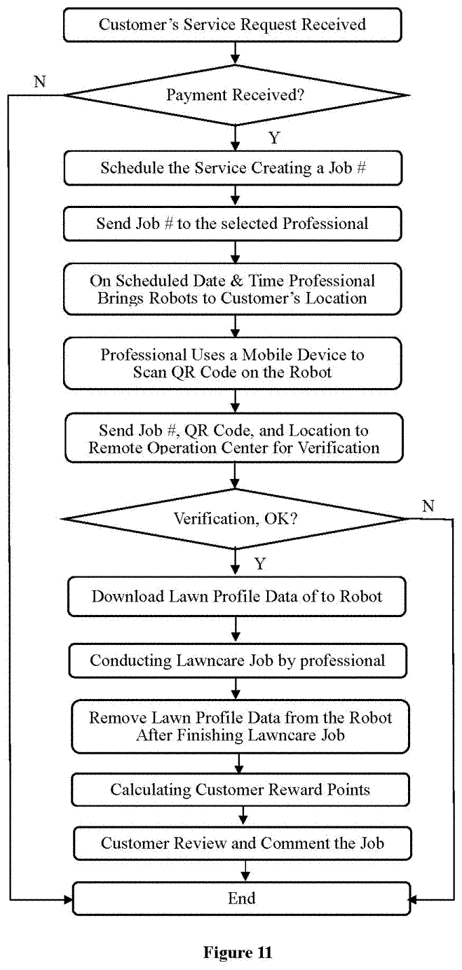

FIG. 11 shows the operational details of the system of lawn mowing and lawn caring services according to the present invention for Customers. Similarly, when the system receives a service request from the mobile device of Customer, the system will first check the payment records of the Customer to see if all of the requisite fees are received in association with the service request. The system will schedule a service in the system, create a Job # (number) for the scheduled service, and then send the Job # as notice to the selected professional who is selected through the mobile device of the Customer. The Job # notice includes the scheduled date and time of the service, location address of the lawn, the nature of the lawn mowing or caring jobs, what types of lawn robot or mower to be used, and so on.

On the date of the schedule, the system will remind the professional to bring the lawn robot or mower to the scheduled location. The system will check to see if the location is correct for validation of address when the mobile device of the professional is turned on upon the arrival of the professional at the location of the lawn. Once the location is validated, the QR code being scanned from the lawn robot will be sent from the mobile device of the professional to the system for verification. Once the QR code information of the equipment is verified, the system will download the requisite lawn profile data of the specified piece of lawn at the correct location to the lawn mower or robot, thereby enabling the initiation of the lawn mower or robot, i.e., getting ready to perform the scheduled lawn caring or mowing jobs as requested. The lawn mower or robot may then conduct the requisite service or services tagged by Job # from the system, on the basis of the downloaded lawn profile data which will generate a lawn mowing or caring plan as displayed on the mobile device of the professional.

When job is done in accordance with the lawn mowing or caring plan, the downloaded lawn profile data will be automatically removed from the mobile device of professional, and the Customer reward points be calculated and sent to the system to finish the job. Whilst the system may receive any comment as review about the experience, if the Customer chooses to put such comments or suggestion.

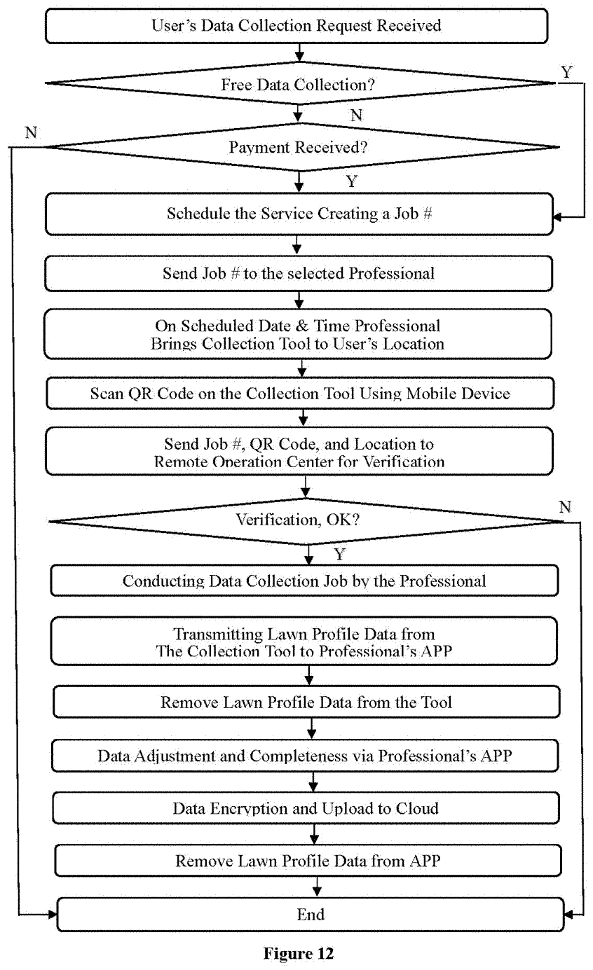

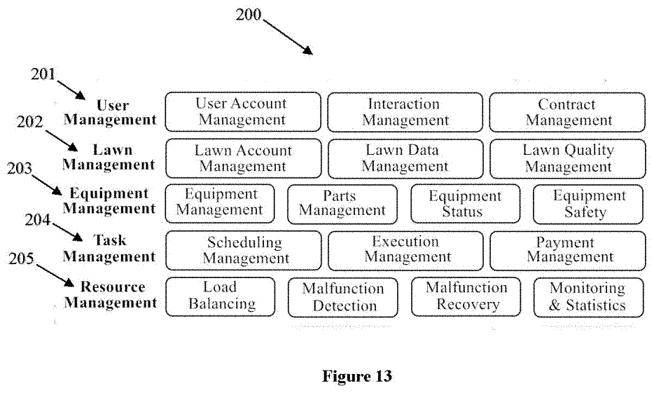

FIG. 12 shows the lawn data collection by the Professionals according to the system of lawn mowing and caring services of the present invention. The lawn profile data collection will be conducted by professionals who have registered with the system of lawn mowing and caring services. Upon receipt of the request for lawn data collection from any user, that is from the mobile devices of any Owners or Customers who are registered with the system. The system will check the payment records of fees of the user who has requested the lawn data collection. Once payment is confirmed, the system will schedule a service, create a Job #, and send the Job # to the selected professional as selected through the mobile device of the user. On the date of the schedule of the lawn data collection, the professional will bring the data collection tool to the user's location, scan the OR code of the collection tool through the mobile device of the professional, and send the Job # and QR code, and location information from the mobile device to the remote operation center of the lawn profile data information management system for verification. With verification, the data collection tool may then start collecting the lawn information or knowledge and then process the information to lawn profile data to be transmitted to the mobile device of the professional. Once done, the lawn profile data so created by the collection tool will be removed from the collection tool. The lawn profile data in the mobile device of the professional received from the collection tool will be processed with any adjustment, and as completed, the lawn profile data will be encrypted and uploaded to the Cloud of the lawn profile data information management system; while the processed lawn profile data will be removed from the mobile device of the professional.

According to the present invention, the method of lawn mowing and caring services comprises the steps of (1) receiving a request for a service with selection of a professional for the service from a mobile device of a registered user, (2) checking receipt of payment of fees from the registered user in association with the service request; (3) scheduling the requested service and creating a job number for the scheduled service; (4) sending a schedule notice with the job number to the selected professional; (5) verifying the location of a piece of lawn upon turning on the mobile device of the professional at an address provided by the registered user together with the service request; (6) validating a QR code of equipment as scanned by the mobile device of the professional from a lawn robot or mower to be used; (7) downloading requisite lawn profile data designated to and associated with the piece of lawn for the service using the validated lawn robot or lawn mower; (8) the validated lawn mower or robot conducting the requested service in accordance with a mowing or caring plan which is created with the downloaded lawn profile data; and (9) automatically removing the downloaded lawn profile data from the lawn mower or robot upon completion of the scheduled lawn services.

The system of lawn mowing and caring services 200 of the present invention may be generally illustrated in FIG. 13, which comprises at least user management 201, lawn or lawn data management 202, equipment management 203, and task management 204, as well as resources management 205. As stated above, a registered user may be an Owner or a Customer, who must get registration before being authorized to use lawn profile data from the lawn profile data information management system. Additional step of checking batter power is required at the equipment management, before conducting the requested service. Further, the lawn data collection will be necessary if the registered user, either Owner or Customer, is requesting a service for the first time on a specific piece of lawn. The lawn data collection will then be scheduled and will be done by a professional service provider as registered. Then, the requested service is assigned as a task being scheduled and executed accordingly.

Moreover, the method of lawn mowing and caring services may include the steps of detecting actual conditions of the piece of lawn; adjusting the mowing or caring plan instantly, processing the lawn profile data from the adjustment of the mowing or caring plan; and sending any update data to the lawn profile data information management system.

1. A method of lawn mowing and caring services in connection with a lawn profile data information management system, comprising the following steps of:
(1) receiving a request for service with selection of a professional for the service from a mobile device of a registered user;
(2) checking receipt of payment of fees from the registered user in association with the service request;
(3) scheduling the requested service and creating a job number for the scheduled service;
(4) sending a schedule notice with the job number to the selected professional;
(5) verifying the location address of a piece of lawn upon turning on the mobile device of the professional provided by the registered user together with the service request;
(6) validating a code of equipment as scanned by the mobile device of professional from a lawn robot or mower to be used;
(7) downloading requisite lawn profile data designated to and associated with the piece of lawn for the services using the validated lawn robot or lawn mower;
(8) the lawn mower or robot conducting the requested service in accordance with a mowing or caring plan which is created with the downloaded lawn profile data; and
(9) automatically removing the downloaded lawn profile data from the lawn mower or robot upon completion of the scheduled lawn services.

2. The method of claim 1, wherein the registered user is either an Owner or a Customer.

3. The method of claim 1, further comprising a step of checking batter power before the validated lawn mower or robot conducts the requested service.

4. The method of claim 1, further comprising an additional step of conducing lawn data collection if the registered user is requesting the service for the first time on the specific piece of lawn.

5. The method of claim 4, wherein the lawn data collection is scheduled to be done by a professional as selected.

6. The method of claim 1, further comprising the steps of detecting actual conditions of the piece of lawn during conducting the requested service; adjusting the mowing or caring plan instantly; modifying the lawn profile data from the adjustment of the mowing or caring plan; and sending an update to the lawn profile data information management system, especially if the adjustment of lawn profile data is permanent.

7. A system of lawn mowing and caring services, comprising a lawn profile data information management system having lawn profile data stored therein; at least one mobile device which communicates wirelessly with the lawn profile data information management system; and at least one robotic lawn mower or a lawn robot which works with the mobile device to acquire requisite lawn profile data from the lawn profile data information management system that is predetermined and designated to a specific piece of lawn to be served before the robotic lawn mower or lawn robot can perform the requisite mowing or caring service on the specific piece of lawn.

8. The system of claim 7, wherein said at least one mobile device is one of a mobile data processor, a mobile information processing device, and a data processing unit as part of the robotic lawn mower or lawncare robot so long as the mobile device is equipped with an APP for processing the lawn profile data related request and task.

9. The system of claim 7, further comprising a user management, with which one of users as classified as owners, customers and professionals gets registered before being authorized to using the lawn profile data from the lawn profile data information management system.

10. The system of claim 9, further comprising an equipment management, with which said at least one mobile device is registered for one of the registered owners who has a lawn mower or lawn robot in possession, the registered customer who does not have a lawn mower or lawn robot, and the registered professional who provides services as requested by one of the registered owners and customers.

11. The system of claim 9, wherein said at least one mobile device of one of the registered users of owner and customer communicates wirelessly with the lawn profile data information management system to send a request of services with selection of professional; and the lawn profile data information management system is so configured to verify the request and schedule the requested service upon verifying receipt of payment of fees from the registered user in association with the service request; and to send a schedule notice with a job number to the selected professional.

12. The system of claim 10, wherein the lawn profile data information management system verifies the location of a piece of lawn upon turning on the mobile device of the professional at an address provided by the registered user together with the request of services; and validates a code of equipment as scanned by the mobile device of the professional from the lawncare robot or lawn mower to be used; and downloads requisite lawn profile data designated to and associated with the piece of lawn for the services, using the validated lawn robot or mower to conduct the requested service in accordance with a mowing or caring plan which is created with the downloaded lawn profile data, which will be removed automatically from the lawn mower or robot upon completion of the scheduled services.

13. The system of claim 11, wherein the validated lawn mower or lawn robot is configured to detect actual conditions of the piece of lawn during conducting the requested service as a basis for adjusting the mowing or caring plan and modifying the lawn profile data from the adjustment of the mowing or caring plan; thereby sending an update to the lawn profile data information management system, if the adjustment of lawn profile data is desired or permanent.
